(19) United States
(12) Patent Application Publication
(10) Pub. No.: US 2025/0353996 A1
(43) Pub. Date: Nov. 20, 2025

(54) INSULATING PLASTIC PARTICLE AND METHOD FOR PRODUCING THE SAME

(71) Applicant: NAN YA PLASTICS CORPORATION, TAIPEI (TW)

(72) Inventors: CHING-YAO YUAN, TAIPEI (TW); CHUN-CHE TSAO, TAIPEI (TW); PEI-YU CHIANG, TAIPEI (TW)

(21) Appl. No.: 18/764,096

(22) Filed: Jul. 3, 2024

(30) Foreign Application Priority Data
May 16, 2024 (TW) 113118031

(51) Int. Cl. C08K 13/02; C08J 3/20; C08K 3/105; C08K 3/26; C08K 3/34; C08K 5/11; C08K 5/12

(52) U.S. Cl. CPC C08K 13/02; C08J 3/203; C08J 2327/06; C08K 3/105; C08K 2003/265; C08K 3/34; C08K 5/11; C08K 5/12

(57) ABSTRACT

An insulating plastic particle and method for producing the same are provided. The insulating plastic particle includes 90 parts by weight to 110 parts by weight of PVC powder, 10 parts by weight to 20 parts by weight of calcium-containing filler, 2 parts by weight to 8 parts by weight of a calcium zinc stabilizer, 30 parts by weight to 50 parts by weight of a plasticizer, and 0.1 parts by weight to 20 parts by weight of an additive. The calcium-containing filler includes calcium carbonate powder and calcined kaolin powder, and a weight ratio between a content of the calcined kaolin powder and a content of the calcium carbonate powder is between 1:2 and 2:1. A weight ratio between a content of the calcium zinc stabilizer and a content of the calcium-containing filler is between 1:4 and 1:7.5.

### CROSS-REFERENCE TO RELATED PATENT APPLICATION

This application claims the benefit of priority to Taiwan Patent Application No. 113118031, filed on May 16, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to an insulating plastic particle and method for producing the same, and more particularly to an insulating plastic particle suitable for producing a cable insulation layer and method for producing the same.

### BACKGROUND OF THE DISCLOSURE

A conventional PVC plastic particle can be used to produce a cable insulation layer, but after a cable covered by the cable insulation layer is soaked in water, a capacity value of the cable is often not sufficiently stable. More specifically, after the cable covered by the cable insulation layer that is made of the conventional PVC plastic particle is soaked in hot water having a temperature of about 90° C., the cable tends to have an excessive capacity value decrease rate, thereby affecting a transmission effect of the cable covered by the above-mentioned cable insulation layer.

### SUMMARY OF THE DISCLOSURE

In response to the above-referenced technical inadequacy, the present disclosure provides an insulating plastic particle and method for producing the same, so as to effectively improve on the unstable capacity value of a cable covered by a cable insulation layer made of a conventional PVC plastic particle after the cable is soaked in water.

In order to solve the above-mentioned problems, one of the technical aspects adopted by the present disclosure is to provide an insulating plastic particle. The insulating plastic particle includes 90 parts by weight to 110 parts by weight of PVC powder, 10 parts by weight to 20 parts by weight of calcium-containing filler, 2 parts by weight to 8 parts by weight of a calcium zinc stabilizer, 30 parts by weight to 50 parts by weight of a plasticizer, and 0.1 parts by weight to 20 parts by weight of an additive. The PVC powder has an average degree of polymerization of between 1,100 and 1,400. An average particle size of the calcium-containing filler is between 1 μm and 2 μm. The calcium-containing filler includes calcium carbonate powder and calcined kaolin powder, and a weight ratio of a content of the calcined kaolin powder divided by a content of the calcium carbonate powder is between 1:2 and 2:1. A weight ratio of a content of the calcium zinc stabilizer divided by a content of the calcium-containing filler is between 1:4 and 1:7.5. The additive is at least one of a heat stabilizer, a stearic acid, an antioxidant, a lubricant, a flame retardant, and a processing aid. The insulating plastic particle is configured to be extruded to form a cable insulation layer, a capacitance value decrease rate of a cable covered by the cable insulation layer being soaked in 90° C. water for 14 days compared to the cable covered by the cable insulation layer being soaked for 1 day is less than or equal to 10%, and a capacitance value decrease rate of the cable covered by the cable insulation layer being soaked in 90° C. water for 14 days compared to the cable covered by the cable insulation layer being soaked for 7 days is less than 10%.

In one of the possible or preferred embodiments, in the calcium-containing filler, the content of the calcium carbonate powder is between 1 part by weight and 5 parts by weight, and the content of the calcined kaolin powder is between 10 parts by weight and 15 parts by weight.

In one of the possible or preferred embodiments, the plasticizer is selected from the group consisting of triisoctyl trimellitate (TOTM), di-n-octyl phthalate (DOP), di (2-ethylhexyl) adipate (DOA), diisooctyl terephthalate (DOTP), and diisononyl phthalate (DINP).

In one of the possible or preferred embodiments, the additive includes 0.1 parts by weight to 3 parts by weight of the heat stabilizer, and the heat stabilizer is selected from the group consisting of barium cadmium heat stabilizer, calcium zinc heat stabilizer, and tin based heat stabilizer. The additive includes 0.1 parts by weight to 3 parts by weight of the stearic acid, and the stearic acid is selected from the group consisting of zinc stearate, barium stearate, magnesium stearate, and calcium stearate. The additive includes 0.1 parts by weight to 3 parts by weight of the antioxidant, and the antioxidant is selected from the group consisting of phosphorus antioxidant and phenolic antioxidant.

In one of the possible or preferred embodiments, the additive includes 0.1 parts by weight to 3 parts by weight of the lubricant, and the lubricant is selected from the group consisting of fatty acid lubricant, stearic acid lubricant, ester lubricant, fatty acid amide lubricant, and silicone lubricant. The additive includes 1 part by weight to 5 parts by weight of the flame retardant, and the flame retardant is selected from the group consisting of antimony trioxide, phosphate ester, zinc borate, aluminum hydroxide, magnesium hydroxide, and chlorinated paraffin. The additive includes 0.1 parts by weight to 3 parts by weight of the processing aid, and the processing aid is selected from the group consisting of polyethylene wax, acrylic copolymer, and a UV absorber.

In order to solve the above-mentioned problems, another one of the technical aspects adopted by the present disclosure is to provide a method for producing an insulating plastic particle. The method includes a preheating process, a mixing process, and a granulating process. The preheating process is implemented by preheating 90 parts by weight to 110 parts by weight of PVC powder at a temperature of between 75° C. and 85° C. for 30 minutes to 35 minutes. The PVC powder has an average degree of polymerization of between 1,100 and 1,400. The mixing process is implemented by using a twin screw mixer to mix 2 parts by weight to 8 parts by weight of a calcium zinc stabilizer and 0.1 parts by weight to 20 parts by weight of an additive for 10 minutes to 15 minutes, adding a plasticizer, adding the PVC powder in batches that is preheated, then adding 10 parts by weight to 20 parts by weight of calcium-containing filler, and continuously mixing for 25 minutes to 30 minutes to obtain a mixed material. An average particle size of the calcium-containing filler is between 1 μm and 2 μm. The calcium-containing filler includes calcium carbonate powder and calcined kaolin powder, and a weight ratio of a content of the calcined kaolin powder divided by a content of the calcium carbonate powder is between 1:2 and 2:1. A weight ratio of a content of the calcium zinc stabilizer divided by a content of the calcium-containing filler is between 1:4 and 1:7.5. The additive is at least one of a heat stabilizer, a stearic acid, an antioxidant, a lubricant, a flame retardant, and a processing aid. The PVC powder is added in batches at time intervals of 10 minutes to 15 minutes. The granulating process is implemented by granulating the mixed material with a Banbury mixer to form an insulating plastic particle. The insulating plastic particle is configured to be extruded to form a cable insulation layer, a capacitance value decrease rate of a cable covered by the cable insulation layer being soaked in 90° C. water for 14 days compared to the cable covered by the cable insulation layer being soaked for 1 day is less than or equal to 10%, and a capacitance value decrease rate of the cable covered by the cable insulation layer being soaked in 90° C. water for 14 days compared to the cable covered by the cable insulation layer being soaked for 7 days is less than 10%.

In one of the possible or preferred embodiments, in the calcium-containing filler, the content of the calcium carbonate powder is between 1 part by weight and 5 parts by weight, and the content of the calcined kaolin powder is between 10 parts by weight and 15 parts by weight.

In one of the possible or preferred embodiments, the plasticizer is selected from the group consisting of triisoctyl trimellitate (TOTM), di-n-octyl phthalate (DOP), di (2-ethylhexyl) adipate (DOA), diisooctyl terephthalate (DOTP), and diisononyl phthalate (DINP).

In one of the possible or preferred embodiments, the additive includes 0.1 parts by weight to 3 parts by weight of the heat stabilizer, and the heat stabilizer is selected from the group consisting of barium cadmium heat stabilizer, calcium zinc heat stabilizer, and tin based heat stabilizer. The additive includes 0.1 parts by weight to 3 parts by weight of the stearic acid, and the stearic acid is selected from the group consisting of zinc stearate, barium stearate, magnesium stearate, and calcium stearate. The additive includes 0.1 parts by weight to 3 parts by weight of the antioxidant, and the antioxidant is selected from the group consisting of phosphorus antioxidant and phenolic antioxidant.

In one of the possible or preferred embodiments, the additive includes 0.1 parts by weight to 3 parts by weight of the lubricant, and the lubricant is selected from the group consisting of fatty acid lubricant, stearic acid lubricant, ester lubricant, fatty acid amide lubricant, and silicone lubricant. The additive includes 1 part by weight to 5 parts by weight of the flame retardant, and the flame retardant is selected from the group consisting of antimony trioxide, phosphate ester, zinc borate, aluminum hydroxide, magnesium hydroxide, and chlorinated paraffin. The additive includes 0.1 parts by weight to 3 parts by weight of the processing aid, and the processing aid is selected from the group consisting of polyethylene wax, acrylic copolymer, and a UV absorber.

Therefore, in the insulating plastic particle and method for producing the same provided by the present disclosure, by virtue of “the weight ratio of the content of the calcined kaolin powder divided by the content of the calcium carbonate powder being between 1:2 and 2:1” and “the weight ratio of the content of the calcium zinc stabilizer divided by the content of the calcium-containing filler being between 1:4 and 1:7.5,” the unstable capacity value of a cable covered by a cable insulation layer made of a conventional PVC plastic particle after the cable is soaked in water can be effectively improved.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a flowchart of a method for producing an insulating plastic particle according to an embodiment of the present disclosure.

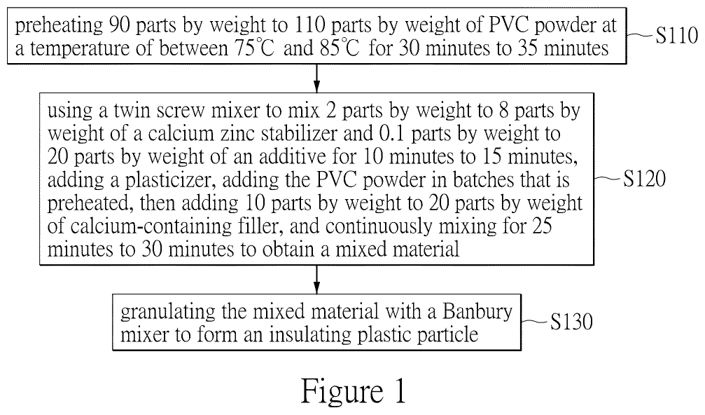

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

### [Insulating Plastic Particle]

An embodiment of the present disclosure provides an insulating plastic particle, the insulating plastic particle can be formed by mixing and granulating PVC powder, calcium-containing filler, a calcium zinc stabilizer, a plasticizer, and an additive, but the present disclosure is not limited thereto. The insulating plastic particle is configured to be extruded to form a cable insulation layer, and a capacitance value decrease rate of a cable covered by the cable insulation layer is not significantly decreased after being soaked in hot water.

In the insulating plastic particle, a content of the PVC powder is 90 parts by weight to 110 parts by weight, a content of the calcium-containing filler is 10 parts by weight to 20 parts by weight, a content of the calcium zinc stabilizer is 2 parts by weight to 8 parts by weight, a content of the plasticizer is 30 parts by weight to 50 parts by weight, and a content of the additive is 0.1 parts by weight to 20 parts by weight.

Preferably, in the insulating plastic particle, the content of the PVC powder is 95 parts by weight to 105 parts by weight, the content of the calcium-containing filler is 15 parts by weight to 20 parts by weight, the content of the calcium zinc stabilizer is 2 parts by weight to 5 parts by weight, the content of the plasticizer is 35 parts by weight to 45 parts by weight, and the content of the additive is 6 parts by weight to 10 parts by weight.

The PVC powder has an average degree of polymerization of between 1,100 and 1,400. It is worth mentioning that, PVC powders having different average degree of polymerization show different properties and can be applied to different fields. In other words, since the insulating plastic particle of the present disclosure is mainly used to produce a cable insulation layer, the PVC powder needs to have the average degree of polymerization between 1,100 and 1,400, and other PVC resin having an average degree of polymerization that is not between 1,100 and 1,400 is not suitable to be compared to the PVC powder of the present disclosure. Preferably, the average degree of polymerization of the PVC powder is between 1,200 and 1,300, but the present disclosure is not limited thereto.

An average particle size of the calcium-containing filler is between 1 μm and 2 μm, and a water content of the calcium-containing filler can be less than or equal to 0.5%, but the present disclosure is not limited thereto. The calcium-containing filler includes calcium carbonate powder and calcined kaolin powder, and a weight ratio of a content of the calcined kaolin powder divided by a content of the calcium carbonate powder is between 1:2 and 2:1. In one embodiment, in the calcium-containing filler, the content of the calcium carbonate powder is between 1 part by weight and 5 parts by weight, and the content of the calcined kaolin powder is between 10 parts by weight and 15 parts by weight.

It is worth mentioning that, the calcined kaolin powder in the calcium-containing filler is mainly used to increase a capacity value of the insulating plastic particle. In addition, after the cable insulation layer made of the insulating plastic particle is soaked in water, the cable insulation layer may have cracks due to the vibration of water. Since the calcium carbonate powder in the calcium-containing filler has a relatively low average particle size (e.g., between 1 μm and 2 μm), the calcium carbonate powder can have excellent dispersion and can fill into the above-mentioned crack. Therefore, the properties of the cable insulation layer are not affected by the cracks.

A weight ratio of a content of the calcium zinc stabilizer divided by a content of the calcium-containing filler is between 1:4 and 1:7.5. Preferably, the weight ratio of the content of the calcium zinc stabilizer divided by the content of the calcium-containing filler is between 1:5 and 1:6. It should be noted that, in the present disclosure, through the weight ratio of the content of the calcium zinc stabilizer divided by the content of the calcium-containing filler, a capacitive stability of the cable insulation layer can be enhanced. In addition, the calcium zinc stabilizer can be a calcium zinc stabilizer (Model: CW-354) produced by Nan Ya Plastics Corporation, but the present disclosure is not limited thereto.

The plasticizer is selected from the group consisting of triisoctyl trimellitate (TOTM), di-n-octyl phthalate (DOP), di (2-ethylhexyl) adipate (DOA), diisooctyl terephthalate (DOTP), and diisononyl phthalate (DINP).

The additive is at least one of a heat stabilizer, a stearic acid, an antioxidant, a lubricant, a flame retardant, and a processing aid.

The additive can include 0.1 parts by weight to 3 parts by weight of the heat stabilizer, and the heat stabilizer is selected from the group consisting of barium cadmium heat stabilizer, calcium zinc heat stabilizer, and tin based heat stabilizer.

The additive can include 0.1 parts by weight to 3 parts by weight of the stearic acid, and the stearic acid is selected from the group consisting of zinc stearate, barium stearate, magnesium stearate, and calcium stearate.

The additive can include 0.1 parts by weight to 3 parts by weight of the antioxidant, and the antioxidant is selected from the group consisting of phosphorus antioxidant and phenolic antioxidant.

The additive can include 0.1 parts by weight to 3 parts by weight of the lubricant, and the lubricant is selected from the group consisting of fatty acid lubricant, stearic acid lubricant, ester lubricant, fatty acid amide lubricant, and silicone lubricant.

The additive can include 1 part by weight to 5 parts by weight of the flame retardant, and the flame retardant is selected from the group consisting of antimony trioxide, phosphate ester, zinc borate, aluminum hydroxide, magnesium hydroxide, and chlorinated paraffin.

The additive can include 0.1 parts by weight to 3 parts by weight of the processing aid, and the processing aid is selected from the group consisting of polyethylene wax, acrylic copolymer, and a UV absorber.

The insulating plastic particle is configured to be extruded to form the cable insulation layer, a capacitance value decrease rate of a cable covered by the cable insulation layer being soaked in 90° C. water for 14 days compared to the cable covered by the cable insulation layer being soaked for 1 day is less than or equal to 10%, and a capacitance value decrease rate of the cable covered by the cable insulation layer being soaked in 90° C. water for 14 days compared to the cable covered by the cable insulation layer being soaked for 7 days is less than 10%. Preferably, the capacitance value decrease rate of the cable covered by the cable insulation layer being soaked in 90° C. water for 14 days compared to the cable covered by the cable insulation layer being soaked for 1 day is between 6% and 10%, and the capacitance value decrease rate of the cable covered by the cable insulation layer being soaked in 90° C. water for 14 days compared to the cable covered by the cable insulation layer being soaked for 7 days is between 3.5% and 8%. In addition, the cable insulation layer can meet the flame resistance specification of UL94-V-0.

### [Method for Producing Insulating Plastic Particle]

The present embodiment further provides a method for producing an insulating plastic particle. The above-mentioned insulating plastic particle can be obtained by implementing the method for producing the insulating plastic particle, but the present disclosure is not limited thereto.

The method for producing the insulating plastic particle includes a preheating process S110, a mixing process S120, and a granulating process S130. However, the method for producing the insulating plastic particle can include other processes according to practical requirements, but the present disclosure is not limited thereto.

In the preheating process S110, 90 parts by weight to 110 parts by weight of PVC powder is preheated at a temperature of between 75° C. and 85° C. for 30 minutes to 35 minutes. The PVC powder has an average degree of polymerization of between 1,100 and 1,400.

In the mixing process S120, a twin screw mixer is used to mix 2 parts by weight to 8 parts by weight of a calcium zinc stabilizer and 0.1 parts by weight to 20 parts by weight of an additive for 10 minutes to 15 minutes, a plasticizer is added, the PVC powder that is preheated is added in batches, then 10 parts by weight to 20 parts by weight of calcium-containing filler is added, and continuous mixing is conducted for 25 minutes to 30 minutes to obtain a mixed material. Through the adding sequence and the mixing time of each component in the mixing process S120, the mixed material can have a relatively stable property.

The additive is at least one of a heat stabilizer, a stearic acid, an antioxidant, a lubricant, a flame retardant, and a processing aid, and the PVC powder is added in batches at time intervals of 10 minutes to 15 minutes.

In the granulating process S130, a Banbury mixer is used to granulate the mixed material to form an insulating plastic particle.

An average particle size of the calcium-containing filler is between 1 μm and 2 μm. The calcium-containing filler includes calcium carbonate powder and calcined kaolin powder, and a weight ratio of a content of the calcined kaolin powder divided by a content of the calcium carbonate powder is between 1:2 and 2:1. A weight ratio of a content of the calcium zinc stabilizer divided by a content of the calcium-containing filler is between 1:4 and 1:7.5.

In one embodiment, in the calcium-containing filler, the content of the calcium carbonate powder is between 1 part by weight and 5 parts by weight, and the content of the calcined kaolin powder is between 10 parts by weight and 15 parts by weight, but the present disclosure is not limited thereto.

The plasticizer is selected from the group consisting of triisoctyl trimellitate (TOTM), di-n-octyl phthalate (DOP), di (2-ethylhexyl) adipate (DOA), diisooctyl terephthalate (DOTP), and diisononyl phthalate (DINP).

The additive is at least one of a heat stabilizer, a stearic acid, an antioxidant, a lubricant, a flame retardant, and a processing aid.

The additive can include 0.1 parts by weight to 3 parts by weight of the heat stabilizer, and the heat stabilizer is selected from the group consisting of barium cadmium heat stabilizer, calcium zinc heat stabilizer, and tin based heat stabilizer.

The additive can include 0.1 parts by weight to 3 parts by weight of the stearic acid, and the stearic acid is selected from the group consisting of zinc stearate, barium stearate, magnesium stearate, and calcium stearate.

The additive can include 0.1 parts by weight to 3 parts by weight of the antioxidant, and the antioxidant is selected from the group consisting of phosphorus antioxidant and phenolic antioxidant.

The additive can include 0.1 parts by weight to 3 parts by weight of the lubricant, and the lubricant is selected from the group consisting of fatty acid lubricant, stearic acid lubricant, ester lubricant, fatty acid amide lubricant, and silicone lubricant.

The additive can include 1 part by weight to 5 parts by weight of the flame retardant, and the flame retardant is selected from the group consisting of antimony trioxide, phosphate ester, zinc borate, aluminum hydroxide, magnesium hydroxide, and chlorinated paraffin.

The additive can include 0.1 parts by weight to 3 parts by weight of the processing aid, and the processing aid is selected from the group consisting of polyethylene wax, acrylic copolymer, and a UV absorber.

The insulating plastic particle is configured to be extruded to form the cable insulation layer, a capacitance value decrease rate of a cable covered by the cable insulation layer being soaked in 90° C. water for 14 days compared to the cable covered by the cable insulation layer being soaked for 1 day is less than or equal to 10%, and a capacitance value decrease rate of the cable covered by the cable insulation layer being soaked in 90° C. water for 14 days compared to the cable covered by the cable insulation layer being soaked for 7 days is less than 10%.

### Experimental Results

For the insulating plastic particle of each of Exemplary Examples 1 to 3 and Comparative Examples 1 to 7, components, a capacitance value decrease rate, a specific gravity, a hardness (shore A), a tensile strength, and a percentage of elongation thereof are listed in Table 1 below, and relevant testing methods are described as follows.

The capacitance value decrease rate test is implemented by soaking the cable covered by the cable insulation layer in hot water having a temperature of 90° C. and measuring the capacity value based on a soaking time. More specifically, change rate of capacity value after soaking for 14 days compared to 1 day=(capacity value of the cable insulation layer soaked for 14 days-capacity value of the cable insulation layer soaked for 1 day)/capacity value of the cable insulation layer soaked for 1 day, and change rate of capacity value after soaking for 14 days compared to 7 days=(capacity value of the cable insulation layer soaked for 14 days-capacity value of the cable insulation layer soaked for 7 days)/capacity value of the cable insulation layer soaked for 7 days.

The specific gravity test is carried out according to ASTM D-792.

The hardness (shore A) test is carried out according to ASTM D-2240.

The tensile strength test is carried out according to ASTM D-638.

The percentage of elongation test is carried out according to ASTM D-638.

TABLE 1
[Components of Exemplary Examples and Comparative Examples
and Test Results of Their Physical and Chemical Properties].

| | Exemplary | Exemplary | Exemplary | Comparative | Comparative | Comparative |
|---|---|---|---|---|---|---|
| Item | example 1 | example 2 | example 3 | example 1 | example 2 | example 3 |
| Content of | 100 | 100 | 100 | 100 | 100 | 100 |
| PVC powder | | | | | | |
| (part by | | | | | | |
| weight) | | | | | | |
| Content of | 17 | 17 | 17 | 17 | 17 | 17 |
| filler | | | | | | |
| (part by | | | | | | |
| weight) | | | | | | |
| Material of | calcined | calcined | calcined | calcined | calcined | calcined |
| filler | kaolin/ | kaolin/ | kaolin/ | kaolin | kaolin/ | kaolin/ |
| | calcium | calcium | calcium | | calcium | calcium |
| | carbonate | carbonate | carbonate | | carbonate | carbonate |
| | (1:1) | (2:1) | (1:2) | | (2:1) | (2:1) |
| Particle size | 1.5 | 1.5 | 1.5 | 1.4 | 8.5 | 22 |
| of filler (μm) | | | | | | |
| Content of | 3 | 3 | 3 | 3 | 3 | 3 |
| stabilizer | | | | | | |
| (part by | | | | | | |
| weight) | | | | | | |
| Material of | calcium | calcium | calcium | calcium | calcium | calcium |
| stabilizer | zinc | zinc | zinc | zinc | zinc | zinc |
| | stabilizer | stabilizer | stabilizer | stabilizer | stabilizer | stabilizer |
| | (powder) | (powder) | (powder) | (powder) | (powder) | (powder) |
| Content of | 1 | 1 | 1 | 1 | 1 | 1 |
| heat | | | | | | |
| stabilizer | | | | | | |
| (part by | | | | | | |
| weight) | | | | | | |
| Content of | 1 | 1 | 1 | 1 | 1 | 1 |
| anti-oxidant | | | | | | |
| (part by | | | | | | |
| weight) | | | | | | |
| Content of | 1 | 1 | 1 | 1 | 1 | 1 |
| lubricant | | | | | | |
| (part by | | | | | | |
| weight) | | | | | | |
| Content of | 2 | 2 | 2 | 2 | 2 | 2 |
| flame | | | | | | |
| retardant | | | | | | |
| (part by | | | | | | |
| weight) | | | | | | |
| Content of | 1 | 1 | 1 | 1 | 1 | 1 |
| processing | | | | | | |
| aid (part by | | | | | | |
| weight) | | | | | | |
| Content of | 40 | 40 | 40 | 40 | 40 | 40 |
| plasticizer | | | | | | |
| (part by | | | | | | |
| weight) | | | | | | |
| Content of | 2 | 2 | 2 | 2 | 2 | 2 |
| stearic acid | | | | | | |
| (part by | | | | | | |
| weight) | | | | | | |
| Change rate | −10% | −6% | −8% | −18% | −13% | −16% |
| of capacity | | | | | | |
| value (cable | | | | | | |
| soaked for | | | | | | |
| 14 days | | | | | | |
| compared to | | | | | | |
| 1 day) | | | | | | |
| Change rate | −8% | −3.5% | −5% | −12% | −11% | −12% |
| of capacity | | | | | | |
| value (cable | | | | | | |
| soaked for | | | | | | |
| 14 days | | | | | | |
| compared to | | | | | | |
| 7 days) | | | | | | |
| Specific | 1.345 | 1.328 | 1.352 | 1.314 | 1.330 | 1.332 |
| gravity | | | | | | |
| Hardness | 95 | 93 | 94 | 89 | 94 | 94 |
| (shore A) | | | | | | |
| Tensile | 232.05 | 251.67 | 226.71 | 229.33 | 230.1 | 219.19 |
| strength | | | | | | |
| (kg/cm²) | | | | | | |
| Percentage | 245.69 | 292.92 | 260.42 | 307.29 | 267.43 | 291.87 |
| of elongation | | | | | | |
| (%) | | | | | | |

| | Comparative | Comparative | Comparative | Comparative |
|---|---|---|---|---|
| Item | example 4 | example 5 | example 6 | example 7 |
| Content of | 100 | 100 | 100 | 100 |
| PVC powder | | | | |
| (part by | | | | |
| weight) | | | | |
| Content of | 17 | 17 | 17 | 17 |
| filler | | | | |
| (part by | | | | |
| weight) | | | | |
| Material of | calcined | calcined | calcined | calcined |
| filler | kaolin/ | kaolin/ | kaolin/ | kaolin/ |
| | calcium | calcium | barium | calcium |
| | carbonate | carbonate | titanate | carbonate |
| | (2:1) | (2:1) | (2:1) | (1:1) |
| Particle size | 1.5 | 1.5 | 1.5 | 8.5 |
| of filler (μm) | | | | |
| Content of | 3 | 3 | 3 | 3 |
| stabilizer | | | | |
| (part by | | | | |
| weight) | | | | |
| Material of | magnesium | calcium zinc | calcium zinc | calcium zinc |
| stabilizer | aluminum | stabilizer | stabilizer | stabilizer |
| | stabilizer | (aqueous) | (powder) | (powder) |
| | (powder) | | | |
| Content of | 1 | 1 | 1 | 1 |
| heat | | | | |
| stabilizer | | | | |
| (part by | | | | |
| weight) | | | | |
| Content of | 1 | 1 | 1 | 1 |
| anti-oxidant | | | | |
| (part by | | | | |
| weight) | | | | |
| Content of | 1 | 1 | 1 | 1 |
| lubricant | | | | |
| (part by | | | | |
| weight) | | | | |
| Content of | 2 | 2 | 2 | 2 |
| flame | | | | |
| retardant | | | | |
| (part by | | | | |
| weight) | | | | |
| Content of | 1 | 1 | 1 | 1 |
| processing | | | | |
| aid (part by | | | | |
| weight) | | | | |
| Content of | 40 | 40 | 40 | 40 |
| plasticizer | | | | |
| (part by | | | | |
| weight) | | | | |
| Content of | 2 | 2 | 2 | 2 |
| stearic acid | | | | |
| (part by | | | | |
| weight) | | | | |
| Change rate | −19% | −12% | −5% | −6% |
| of capacity | | | | |
| value (cable | | | | |
| soaked for | | | | |
| 14 days | | | | |
| compared to | | | | |
| 1 day) | | | | |
| Change rate | −12% | −6% | 12% | 14% |
| of capacity | | | | |
| value (cable | | | | |
| soaked for | | | | |
| 14 days | | | | |
| compared to | | | | |
| 7 days) | | | | |
| Specific | 1.345 | 1.327 | 1.350 | 1.334 |
| gravity | | | | |
| Hardness | 92 | 93 | 92 | 90 |
| (shore A) | | | | |
| Tensile | 202.13 | 249.57 | 225.51 | 225.71 |
| strength | | | | |
| (kg/cm²) | | | | |
| Percentage | 189.51 | 303.054 | 329.37 | 268.47 |
| of elongation | | | | |
| (%) | | | | |

### Discussion Results

As shown in Exemplary Examples 1 to 3, the ratio of the content of the calcined kaolin powder divided by the content of the calcium carbonate powder is between 2:1 and 1:2, the cable insulation layer made of the insulating plastic particle can have a relatively low capacity value decrease rate, a specific gravity of between 1.328 and 1.352, a hardness of between 93 and 95, a tensile strength of between 226.71 kg/cm² and 251.67 kg/cm², and a percentage of elongation of between 245.68% and 292.92%.

In Comparative Example 1, the filler only includes calcined kaolin powder but does not include calcium carbonate powder, and accordingly, the capacity value decrease rate of the cable insulation is excessive and the hardness is not enough. In Comparative Examples 2 and 3, the particle size of the filler is too high, so that the capacity value decrease rate of the cable insulation is too great.

In Comparative Examples 4 and 5, the materials of the stabilizers are respectively aluminum magnesium stabilizer and aqueous calcium zinc stabilizer that have worse effect than the powder calcium zinc stabilizer, so that the capacity value decrease rate of the cable insulation is too great. In Comparative Examples 6 and 7, the particle size and the content of the filler causes uneven dispersion of the filler and the partial swelling of the cable insulation layer, and so that the capacity value of the cable covered by the cable insulation layer is increased.

### Beneficial Effects of the Embodiment

In conclusion, in the insulating plastic particle and method for producing the same provided by the present disclosure, by virtue of “the weight ratio of the content of the calcined kaolin powder divided by the content of the calcium carbonate powder being between 1:2 and 2:1” and “the weight ratio of the content of the calcium zinc stabilizer divided by the content of the calcium-containing filler being between 1:4 and 1:7.5,” the unstable capacity value of a cable covered by a cable insulation layer made of a conventional PVC plastic particle after the cable is soaked in water can be effectively improved.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An insulating plastic particle, comprising:
90 parts by weight to 110 parts by weight of PVC powder, wherein the PVC powder has an average degree of polymerization of between 1,100 and 1,400;
10 parts by weight to 20 parts by weight of calcium-containing filler, wherein an average particle size of the calcium-containing filler is between 1 μm and 2 μm, wherein the calcium-containing filler includes calcium carbonate powder and calcined kaolin powder, and a weight ratio of a content of the calcined kaolin powder divided by a content of the calcium carbonate powder is between 1:2 and 2:1;
2 parts by weight to 8 parts by weight of a calcium zinc stabilizer, wherein a weight ratio of a content of the calcium zinc stabilizer divided by a content of the calcium-containing filler is between 1:4 and 1:7.5;
30 parts by weight to 50 parts by weight of a plasticizer; and
0.1 parts by weight to 20 parts by weight of an additive, wherein the additive is at least one of a heat stabilizer, a stearic acid, an antioxidant, a lubricant, a flame retardant, and a processing aid;
wherein the insulating plastic particle is configured to be extruded to form a cable insulation layer, a capacitance value decrease rate of a cable covered by the cable insulation layer being soaked in 90° C. water for 14 days relative to the cable covered by the cable insulation layer being soaked for 1 day is less than or equal to 10%, and a capacitance value decrease rate of the cable covered by the cable insulation layer being soaked in 90° C. water for 14 days relative to the cable covered by the cable insulation layer being soaked for 7 days is less than 10%.

2. The insulating plastic particle according to claim 1, wherein, in the calcium-containing filler, the content of the calcium carbonate powder is between 1 part by weight and 5 parts by weight, and the content of the calcined kaolin powder is between 10 parts by weight and 15 parts by weight.

3. The insulating plastic particle according to claim 1, wherein the plasticizer is selected from the group consisting of triisoctyl trimellitate (TOTM), di-n-octyl phthalate (DOP), di (2-ethylhexyl) adipate (DOA), diisooctyl terephthalate (DOTP), and diisononyl phthalate (DINP).

4. The insulating plastic particle according to claim 1, wherein the additive includes 0.1 parts by weight to 3 parts by weight of the heat stabilizer, and the heat stabilizer is selected from the group consisting of barium cadmium heat stabilizer, calcium zinc heat stabilizer, and tin based heat stabilizer, wherein the additive includes 0.1 parts by weight to 3 parts by weight of the stearic acid, and the stearic acid is selected from the group consisting of zinc stearate, barium stearate, magnesium stearate, and calcium stearate, and wherein the additive includes 0.1 parts by weight to 3 parts by weight of the antioxidant, and the antioxidant is selected from the group consisting of phosphorus antioxidant and phenolic antioxidant.

5. The insulating plastic particle according to claim 1, wherein the additive includes 0.1 parts by weight to 3 parts by weight of the lubricant, and the lubricant is selected from the group consisting of fatty acid lubricant, stearic acid lubricant, ester lubricant, fatty acid amide lubricant, and silicone lubricant, wherein the additive includes 1 part by weight to 5 parts by weight of the flame retardant, and the flame retardant is selected from the group consisting of antimony trioxide, phosphate ester, zinc borate, aluminum hydroxide, magnesium hydroxide, and chlorinated paraffin, and wherein the additive includes 0.1 parts by weight to 3 parts by weight of the processing aid, and the processing aid is selected from the group consisting of polyethylene wax, acrylic copolymer, and a UV absorber.

6. A method for producing an insulating plastic particle, comprising:
a preheating process implemented by preheating 90 parts by weight to 110 parts by weight of PVC powder at a temperature of between 75° C. and 85° C. for 30 minutes to 35 minutes, wherein the PVC powder has an average degree of polymerization of between 1,100 and 1,400;
a mixing process implemented by using a twin screw mixer to mix 2 parts by weight to 8 parts by weight of a calcium zinc stabilizer and 0.1 parts by weight to 20 parts by weight of an additive for 10 minutes to 15 minutes, adding a plasticizer, adding the PVC powder in batches that is preheated, then adding 10 parts by weight to 20 parts by weight of calcium-containing filler, and continuously mixing for 25 minutes to 30 minutes to obtain a mixed material, wherein an average particle size of the calcium-containing filler is between 1 μm and 2 μm, wherein the calcium-containing filler includes calcium carbonate powder and calcined kaolin powder, and a weight ratio of a content of the calcined kaolin powder divided by a content of the calcium carbonate powder is between 1:2 and 2:1, wherein a weight ratio of a content of the calcium zinc stabilizer divided by a content of the calcium-containing filler is between 1:4 and 1:7.5, wherein the additive is at least one of a heat stabilizer, a stearic acid, an antioxidant, a lubricant, a flame retardant, and a processing aid, and wherein the PVC powder is added in batches at time intervals of 10 minutes to 15 minutes; and
a granulating process implemented by granulating the mixed material with a Banbury mixer to form an insulating plastic particle,
wherein the insulating plastic particle is configured to be extruded to form a cable insulation layer, a capacitance value decrease rate of a cable covered by the cable insulation layer being soaked in 90° C. water for 14 days relative to the cable covered by the cable insulation layer being soaked for 1 day is less than or equal to 10%, and a capacitance value decrease rate of the cable covered by the cable insulation layer being soaked in 90° C. water for 14 days relative to the cable covered by the cable insulation layer being soaked for 7 days is less than 10%.

7. The method according to claim 6, wherein, in the calcium-containing filler, the content of the calcium carbonate powder is between 1 part by weight and 5 parts by weight, and the content of the calcined kaolin powder is between 10 parts by weight and 15 parts by weight.

8. The method according to claim 6, wherein the plasticizer is selected from the group consisting of triisoctyl trimellitate (TOTM), di-n-octyl phthalate (DOP), di (2-ethylhexyl) adipate (DOA), diisooctyl terephthalate (DOTP), and diisononyl phthalate (DINP).

9. The method according to claim 6, wherein the additive includes 0.1 parts by weight to 3 parts by weight of the heat stabilizer, and the heat stabilizer is selected from the group consisting of barium cadmium heat stabilizer, calcium zinc heat stabilizer, and tin based heat stabilizer, wherein the additive includes 0.1 parts by weight to 3 parts by weight of the stearic acid, and the stearic acid is selected from the group consisting of zinc stearate, barium stearate, magnesium stearate, and calcium stearate, and wherein the additive includes 0.1 parts by weight to 3 parts by weight of the antioxidant, and the antioxidant is selected from the group consisting of phosphorus antioxidant and phenolic antioxidant.

10. The method according to claim 6, wherein the additive includes 0.1 parts by weight to 3 parts by weight of the lubricant, and the lubricant is selected from the group consisting of fatty acid lubricant, stearic acid lubricant, ester lubricant, fatty acid amide lubricant, and silicone lubricant, wherein the additive includes 1 part by weight to 5 parts by weight of the flame retardant, and the flame retardant is selected from the group consisting of antimony trioxide, phosphate ester, zinc borate, aluminum hydroxide, magnesium hydroxide, and chlorinated paraffin, and wherein the additive includes 0.1 parts by weight to 3 parts by weight of the processing aid, and the processing aid is selected from the group consisting of polyethylene wax, acrylic copolymer, and a UV absorber.

11. An insulating plastic particle obtained by implementing the method as claimed in claim 6.
